(19) United States
(12) Patent Application Publication
(10) Pub. No.: US 2013/0295406 A1
(43) Pub. Date: Nov. 7, 2013

(54) SHEET MATERIAL HAVING A CONCAVE-CONVEX PART, AND VEHICLE PANEL AND LAMINATED STRUCTURE USING THE SAME

(71) Applicant: Masaya Takahashi, Aichi-ken (JP)

(72) Inventor: Masaya Takahashi, Aichi-ken (JP)

(73) Assignee: SUMITOMO LIGHT METAL INDUSTRIES, LTD., Tokyo (JP)

(21) Appl. No.: 13/993,492

(22) PCT Filed: May 19, 2011
(86) PCT No.: PCT/JP2011/061477

§ 371 Date: Jun. 12, 2013

(30) Foreign Application Priority Data
Dec. 17, 2010 (JP) 2010-281277

(51) Int. Cl. B62D 25/00

(52) U.S. Cl. CPC B62D 25/00
USPC 428/604

(57) ABSTRACT

A sheet material (1) includes a stiffness-increasing concave-convex part (20). A first reference plane (K1) and a second reference plane (K2) serve as a reference system. Numerous at least substantially (H) shaped first reference areas (213), each including two parallel longitudinal bar parts (214) and a latitudinal bar part (215) that connects center portions the two parallel longitudinal bar parts together, are arrayed with the same orientation in the second reference plane (K2). First areas (21) respectively protrude from the first reference areas (213) in the second reference plane (K2) toward the first reference plane (K1). Each first area (21) includes a first top surface (211), which is a reduced projection of its first reference area (213) into the first reference plane (K1), and first side surfaces (212) that connect the outer periphery of the first top surface (211) with the outer periphery of the corresponding first reference area (213).

### TECHNICAL FIELD

The present invention relates to a sheet material whose stiffness is increased by the formation of a concave-convex part, and to a vehicle panel and a laminated structure that are configured using the same.

### BACKGROUND ART

With the aim of reducing the weight of, for example, an automobile, the potential replacement of the material of components comprising steel sheets and the like with a lightweight material such as an aluminum alloy sheet is being studied and implemented. In such a case, assuming that the weight is reduced, it is necessary that the required stiffness be ensured.

To date, studies conducted to increase stiffness without increasing the thickness of the sheet material have provided the sheet material with a wave shape, a concave-convex shape, and the like, and the stiffness has been increased by virtue of the shape.

As an example of implementing a convex-concave shape, one of the components, called a heat insulator, of an automobile is formed of a sheet material. As a material therefor, Patent Document 1 proposes the formation of numerous protruding parts by embossing in order to ensure sufficient stiffness without increasing sheet thickness. In addition, sheet materials have also been proposed (refer to Patent Documents 2-7) that increase stiffness not only in a heat insulator but also in various applications by forming a concave-convex part via embossing and the like.

### PRIOR ART LITERATURE

### Patent Documents

Patent Document 1: Japanese Patent No. 4388558

Patent Document 2: Japanese Patent No. 3332353

Patent Document 3: Japanese Unexamined Patent Application Publication No. 2000-257441

Patent Document 4: Japanese Unexamined Patent Application Publication No. 9-254955

Patent Document 5: Japanese Unexamined Patent Application Publication No. 2000-288643

Patent Document 6: Japanese Unexamined Patent Application Publication No. 2002-307117

Patent Document 7: Japanese Unexamined Patent Application Publication No. 2002-321018

### SUMMARY

### Problems Solved by the Invention

A sheet material wherein corrugations, numerous concave-convex parts, and the like are formed is actually stiffer than a flat sheet in which concave-convex parts are not formed. Nevertheless, the stiffness of a sheet material provided with a corrugated shape has directionality, namely, there are cases wherein even though the stiffness increases in one direction, the desired stiffness increase effect is not obtained in another direction. In addition, in the sheet material provided with the concave-convex part described in Patent Document 1, Patent Document 2, and the like, even though stiffness anisotropy is reduced, the stiffness increase effect thereof is approximately only two times and the weight reduction effect thereof is approximately only 20% of a flat sheet wherein the concave-convex part is not formed, and these effects cannot necessarily satisfy the demand. Consequently, it cannot be said that the optimal concave-convex part shape that both increases stiffness and reduces weight has yet been elucidated, and there is always a demand for further increases in the stiffness increase effect and the weight reduction effect. In addition, apart from the need to reduce weight, there is also anticipation for a material cost reduction effect; when it comes to a sheet material (i.e., a sheet-shaped material), there is demand for increased stiffness and decreased weight—regardless of the material.

In addition, there is demand for a high degree of stiffness over and above that of the conventional art even for, for example, laminated structures that use a sheet material having a concave-convex part that features a high stiffness increase effect, vehicle panels that incorporate a sheet material having a concave-convex part that features a high stiffness increase effect, and the like.

The present invention was conceived considering this background, and it is an object of the present invention to provide a sheet material that has a concave-convex part pattern and whose stiffness is higher than that of the conventional art, and to provide a vehicle panel and a laminated structure that uses the same.

### Means for Solving the Problems

A first aspect of the invention is a sheet material whose stiffness is increased by the formation of a concave-convex part, wherein

a first reference plane and a second reference plane, which are two virtual planes that are spaced apart from and parallel to one another, are used as a reference;

numerous substantially H shaped first reference areas, each comprising two parallel longitudinal bar parts and a latitudinal bar part that connects them together at their center portions, are arrayed with the same orientation in the second reference plane;

a plurality of first reference area rows, wherein a plurality of the first reference areas is arrayed in a row in the X directions in each of the first reference area rows, is formed wherein the longitudinal directions of the longitudinal bar parts are the Y directions and the directions orthogonal thereto are the X directions;

any arbitrary two rows of the first reference area rows adjacent to one another in the Y directions are disposed with a positional relationship such that a state obtains wherein a total of two of the longitudinal bar parts of two of the first reference areas—one longitudinal bar part per first reference area—adjacent to one another in the X directions and belonging to one of the first reference area rows penetrates the space between a pair of the longitudinal bar parts of one of the first reference areas belonging to the other first reference area row; and

the concave-convex part is provided with first areas, each of which comprises a first top surface that is a projection of its first reference area into the first reference plane at either unity or reduced magnification such that the first top surface protrudes from the first reference area in the second reference plane toward the first reference plane, and first side surfaces that connect the contour of that first top surface and the contour of the corresponding first reference area.

Another aspect of the invention is a laminated structure wherein multiple sheet materials are laminated, wherein at least one of the sheet materials is a sheet material that has the concave-convex part.

Yet another aspect of the present invention is a vehicle panel that has an outer panel and an inner panel, which is joined to a rear surface of the outer panel, wherein one or both of the inner panel and the outer panel comprises a sheet material that has a concave-convex part.

### Effects of the Invention

In the sheet material having the concave-convex part, the concave-convex part is provided with the first areas, each of which protrudes from the first reference areas defined in the second reference plane toward the first reference plane. Furthermore, each of the first areas comprises the first top surface and the first side surfaces, which connect the contour of that first top surface and the contour of the corresponding first reference area.

Because it has such a structure, the sheet material has superior bending stiffness as well as superior energy absorption characteristics.

The following considers reasons why the stiffness is increased. Namely, each of the first areas comprises: one of the first top surfaces, which is disposed in the first reference plane disposed at a position that is spaced apart from the neutral plane of the sheet material, and the first side surfaces that intersect in the thickness directions of the sheet material. Consequently, a large amount of the sheet material can be disposed at a position that is spaced apart from the neutral plane of the sheet material. Accordingly, the large amount of material can be used effectively, and thereby the stiffness increase effect can be increased greatly.

In particular, the first reference areas, which are the basic shapes of the first areas, are each substantially H shaped, and the positional relationship of adjacency in the X directions is established as mentioned above, wherein the longitudinal bar parts of two of the first reference areas penetrate, in the Y directions, the space between the pair of longitudinal bar parts of one of the first reference areas. Thereby, the second moment of area can be improved in any cross section taken along any direction, thereby making it possible to obtain a concave-convex shape with a superior bending stiffness increase effect and low stiffness anisotropy. In addition, attendant with the increase in the stiffness, it is also possible to obtain the effect of improving damping characteristics; in addition, the concave-convex shape makes it possible to obtain the effect of suppressing sound reverberations.

In the abovementioned laminated structure, a laminated structure of extremely high stiffness can be easily obtained by using, in at least part of the abovementioned laminated structure, the sheet material having the concave-convex part that exhibits the stiffness increase effect as mentioned above. In addition, it is possible to obtain the damping improvement effect attendant with the increase in stiffness, and to obtain the sound absorption improvement effect by virtue of containing air layers.

In the vehicle panel, the sheet material that has the concave-convex part having the stiffness increase effect as mentioned above is used in the outer panel or the inner panel, or both, and thereby it is possible to easily obtain a vehicle panel whose stiffness is extremely high. In addition, it is possible to obtain the damping improvement effect attendant with the stiffness increase, and to obtain the sound absorption improvement effect by virtue of containing air layers.

### BRIEF DESCRIPTION OF THE DRAWINGS

FIG. 1 is a partial plan view of a sheet material having a concave-convex part according to a first embodiment.

FIG. 2 is a partial enlarged view of an auxiliary cross section taken along the A-A line in FIG. 1.

FIG. 3 is a partial oblique view of the sheet material having the concave-convex part according to the first embodiment.

FIG. 4 is an explanatory diagram that shows a second reference plane according to the first embodiment.

FIG. 5 is a partial plan view of the sheet material, wherein the forming direction of the concave-convex part has been changed, according to the first embodiment.

FIG. 6 is a partial plan view of the sheet material having the concave-convex part according to a second embodiment.

FIG. 7 is a partial oblique view of the sheet material having the concave-convex part according to the second embodiment.

FIG. 8 is an explanatory diagram that shows the second reference plane according to the second embodiment.

FIG. 9 is a partial plan view of the sheet material, wherein the forming direction of the concave-convex part has been changed, according to the second embodiment.

FIG. 10 is a partial plan view of the sheet material having the concave-convex part according to a third embodiment.

FIG. 11 is a partial enlarged view of an auxiliary cross section taken along the B-B line in FIG. 10.

FIG. 12 is a partial plan view of the sheet material, wherein the forming direction of the concave-convex part has been changed, according to the third embodiment.

FIG. 13 is an explanatory diagram that shows the second reference plane, wherein first reference areas are spread out, according to a fourth embodiment.

FIG. 14 is an explanatory diagram that shows the second reference plane, wherein second reference areas are disposed between the first reference areas adjacent in the X directions and between the first reference areas adjacent in the Y directions, according to the fourth embodiment.

FIG. 15 is an explanatory diagram that shows a cylindrical member that comprises the concave-convex part according to a fifth embodiment.

FIG. 16 is an explanatory development view of a laminated structure according to a sixth embodiment.

FIG. 17 is an explanatory development view of a vehicle panel according to a seventh embodiment.

### DETAILED DESCRIPTION OF EMBODIMENTS

In the present invention, the expression “H shape” refers to shapes that can generally be recognized as H shapes; for example, shapes that would naturally be allowed include: shapes wherein the sides are somewhat curved; so-called fillets wherein a round and the like needed for forming a molded shape is created in a corner part, a surface, and the like; and shapes provided with a so-called curvature.

In addition, in the present invention, the expression “parallel” is not limited to the narrow concept of geometry and may be anything that can generally be recognized as being parallel.

In addition, the first top surfaces in the sheet material that has the concave-convex part can also be configured by surfaces in the first reference plane or by regions that protrude from the first reference plane in the reverse direction to the direction in which the second reference plane is disposed. Examples of the shape of the protruding regions include a dome, a ridgeline, and a cone, but the shape of the protruding regions is not limited thereto.

In addition, in any arbitrary two rows of the first reference area rows that are adjacent in the Y directions, the amount by which a total of two of the longitudinal bar parts of two of the first reference areas—one longitudinal bar part per first reference area—that are adjacent in the X directions and belong to one of the first reference area rows penetrates the space between a pair of the longitudinal bar parts of one of the first reference areas belonging to the other first reference area row is preferably in the range of 0.2-1.0 E, in contrast to a protrusion length E, which is the amount by which the longitudinal bar parts protrude from the latitudinal bar parts in the Y directions. In this case, it is possible to obtain formability and a sufficient stiffness increase effect. If the penetration is less than 0.2 E, then it might not be possible to obtain a sufficient stiffness increase effect. In addition, if the penetration exceeds E, then the prescribed shape cannot be obtained.

In addition, it is also possible to make the penetrations different for each of the two adjacent first reference areas. In this case, too, it is possible to obtain a sheet material that exhibits both superior bending stiffness and excellent energy absorption characteristics.

In addition, in the second reference plane, the first reference areas are preferably disposed regularly. If the first reference areas are disposed irregularly, then the shape of the concave-convex part will also become irregular, and thereby local changes in stiffness may arise, resulting in unstable stiffness and anisotropy thereof.

In addition, the first reference areas may be disposed without any gaps over the entire surface of the second reference plane; it is also possible to provide gaps between the first reference areas and to have those gap portions coexist, as second reference areas, with the first reference areas as follows. Namely, it is also possible for the first reference areas and the second reference areas, which are those areas that exclude the first reference areas, to coexist in the second reference plane, and to provide second areas, each of which comprises a second top surface that is a projection of its second reference area into the first reference plane at either unity or reduced magnification such that the second top surface protrudes from the second reference area toward the first reference plane and second side surfaces that connect the contour of that second top surface and the contour of the corresponding second reference area, or plane areas, each of which comprises the second reference area in the second reference plane.

If the second areas are provided, then the concave-convex part comprises the first areas and the second areas, which are formed from the second reference plane to the first reference plane. In this case, too, it is possible to obtain a sheet material that exhibits both superior bending stiffness and excellent energy absorption characteristics. In addition, if the plane areas are provided, then the concave-convex part comprises the first areas and the plane areas. In this case, the first top surfaces can be formed in the first reference plane, which is spaced apart from the neutral plane of the sheet material, and the plane areas can be formed in the second reference plane. Accordingly, numerous members can be disposed on both sides of the neutral plane, which makes it possible to further enhance the bending stiffness increase effect of the sheet material having the concave-convex part.

In addition, if the second areas are provided, then each of the second top surfaces can also comprise a surface in the first reference plane or comprise a region that protrudes in a direction opposite to the direction in which the second reference plane is disposed with respect to the first reference plane. In addition, each of the plane areas can also comprise a surface in the second reference plane or comprise a region that protrudes in a direction opposite to the direction in which the first reference plane is disposed with respect to the second reference plane. Examples of the shape of the protruding regions include a dome, a ridgeline, and a cone, but the shape of the protruding regions is not limited thereto.

In addition, the width dimension in the X directions of each of the longitudinal bar parts is designated as a reference dimension A (mm), and a dimension B (mm), which is the width of each of the longitudinal bar parts in the Y directions, preferably is related to the reference dimension A (mm) by 3A≦B≦13A; furthermore, a dimension C (mm), which is the width of each of the latitudinal bar parts in the X directions, preferably is related to the reference dimension A (mm) by 2A≦C≦10A; furthermore, a dimension D (mm), which is the width of each of the latitudinal bar parts in the Y directions, preferably is related to the reference dimension A (mm) by A≦D≦3A; furthermore, the dimension B (mm) and the dimension D (mm) preferably have the relationship B≧D+2A. In this case, it is possible to form a superior concave-convex part shape wherein the bending stiffness increase effect is high and the bending stiffness anisotropy is low.

If the dimension B (mm) is less than 3A or exceeds 13A, then the bending stiffness anisotropy increases, which is not preferable.

In addition, if the dimension C (mm) is less than 2A, then the first reference areas cannot be disposed in the sheet material that has the concave-convex part. In addition, if the dimension C (mm) exceeds 10A, then the bending stiffness anisotropy increases, which is not preferable.

In addition, if the dimension D (mm) is less than A or exceeds 3A, then the bending stiffness anisotropy increases, which is not preferable.

In addition, if the relationship between the dimension B (mm) and the dimension D (mm) becomes B<D+2A, then the shape of each of the first reference areas cannot be made a substantially H shape, and the bending stiffness anisotropy increases, neither of which is preferable.

In addition, an inclination angle θ₁(°) of the first side surface with respect to the second reference plane is preferably in the range of 10°-90°, and an inclination angle θ₂(°) of the second side surface with respect to the second reference plane is preferably in the range of 10°-90°. If the inclination angle θ₁(°) of the first side surface and the inclination angle θ₂(°) of the second side surface are in the range of 10°-90°, then a concave-convex part shape that has a superior stiffness increase factor can be obtained while ensuring formability.

If the inclination angle θ₁(°) of the first side surface and the inclination angle θ₂(°) of the second side surface are less than 10°, then it becomes difficult to increase the height with which the first areas and the second areas protrude, which decreases the stiffness increase factor. In addition, if the inclination angle θ₁(°) of the first side surface and the inclination angle θ₂(°) of the second side surface exceed 90°, then forming the concave-convex part will be problematic, and such an area will not be needed.

Furthermore, in a case wherein a metal sheet is press formed, because of problems with formability, the upper limit value of the inclination angle θ₁(°) of the first side surface and the upper limit value of the inclination angle θ₂(°) of the second side surface are more preferably less than or equal to 70°. Accordingly, the range is more preferably 10°-70°.

In addition, the first side surface and the second side surface comprise a plurality of surfaces, but it is not necessary for all of those surfaces to have the same inclination angle; for example, the inclination angle may vary with the region. However, every surface is preferably within the abovementioned preferable inclination angle range.

In addition, at least part of the first reference plane and at least part of the second reference plane are preferably parallel curved surfaces.

In this case, the superior sheet material that has the concave-convex part can be deformed into various shapes, and the range of application can be expanded.

In addition, in a sheet material that has the concave-convex part, the sheet material is preferably one wherein the concave-convex part is formed by press forming a metal sheet. The concave-convex part can be easily formed by plastic working a metal sheet such as by press forming, for example, embossing, or by roll forming. Consequently, the superior concave-convex part shape can be adapted to a metal sheet comparatively easily. Various materials that can be plastically worked, such as aluminum alloy, steel, and copper alloy, can be used as the material of the metal sheet.

Furthermore, in addition to plastic working such as rolling, it is also possible to use casting, cutting, and the like as the forming method.

In addition, as long as it has the concave-convex part, the sheet material is also effective with materials other than metal; for example, the sheet material can also be a resin sheet and the like. In the case of a resin material and the like, the concave-convex part can be formed by, for example, injection molding or hot pressing. Compared with metal material, resin material tends not to be constrained in its formation and has a greater number of degrees of freedom in its design.

In addition, a sheet thickness t (mm) prior to the formation of the metal sheet is preferably 0.03-6.0 mm. When the sheet thickness of the metal sheet is less than 0.03 mm or exceeds 6.0 mm, there is little need to increase its stiffness in application.

In addition, a ratio A/t of the reference dimension A (mm) to the sheet thickness t (mm) is preferably 10-2000.

If the ratio A/t is less than 10, then there is a risk that forming will become difficult; moreover, if the ratio A/t exceeds 2000, then there is a risk that problems will arise, such as it being no longer possible to sufficiently form the concave-convex part shape, and that stiffness will decrease.

In addition, a ratio H/t of a distance H (mm) between the first reference plane and the second reference plan to the sheet thickness t (mm), and the maximum inclination angle θ₁(°) formed between the first side surface and the second reference plane preferably have the relationship 1≦(H/t)≦−3θ₁+272; and the ratio H/t and the maximum inclination angle θ₂(°) formed between the second side surface and the second reference plane preferably have the relationship 1≦(H/t)≦−3θ₂+272.

If the ratio H/t is less than 1, then there is a risk that a problem will arise wherein the stiffness increase effect produced by the formation of the first areas will not be sufficient. Moreover, if the ratio H/t exceeds −3θ₁+272, then there is a risk that a problem will arise wherein forming will become difficult. Likewise, if the ratio H/t is less than 1, then there is a risk that a problem will arise wherein the stiffness increase effect produced by the formation of the second areas will not be sufficient. Moreover, if the ratio H/t exceeds −3θ₂+272, then there is a risk that a problem will arise wherein forming will become difficult.

In addition, in the abovementioned laminated structure, it is possible to configure a laminated body with a three-layer structure wherein the sheet material that has the concave-convex part is used as one core material, and one flat face sheet is provided and disposed on each side thereof. In addition, it is also possible to configure a structure that repeats such a basic structure, namely, a multilayer structure wherein a plurality of the sheet materials, each sheet material having the concave-convex part, is stacked, with a flat face sheet inserted after every sheet material.

In addition, it is also possible to adopt a structure wherein the plurality of sheet materials having the concave-convex parts are directly stacked and used as the core material, and the flat face sheets are joined to a surface on one side thereof or to surfaces on both sides thereof.

In addition, it is also possible to configure a laminated structure in the state wherein the plurality of the sheet materials having the concave-convex parts is just directly stacked.

The number of the sheet materials stacked can be modified in accordance with the application and the required characteristics.

In addition, the abovementioned vehicle panel is not limited to the hood of an automobile and can also be adapted to: a panel, such as a door, a roof, a floor, and a trunk lid; a reinforcing member; and an energy absorbing member, such as a bumper, a crush box, a door beam, and the like. In addition, a steel sheet, an aluminum alloy sheet, or the like can also be used as the outer panel and the inner panel.

If the outer panel comprises an aluminum alloy sheet, then, for example, a 6000 series alloy is ideal because it is relatively low cost. In addition, if the inner panel comprises an aluminum alloy sheet, then, for example, a 5000 series alloy sheet is ideal because it has relatively good formability.

### Embodiments

### First Embodiment

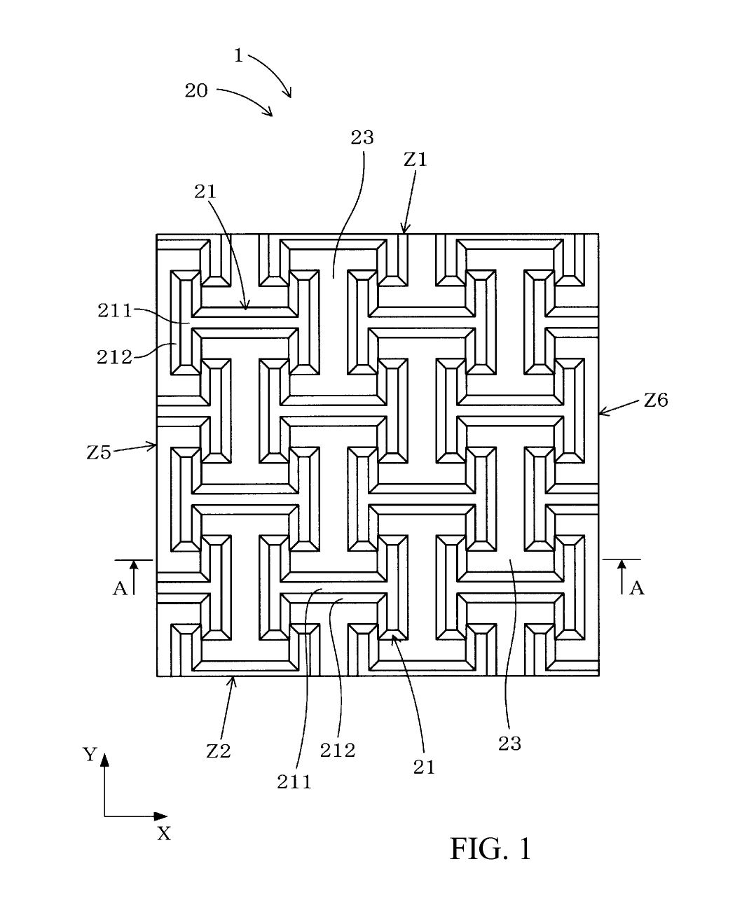

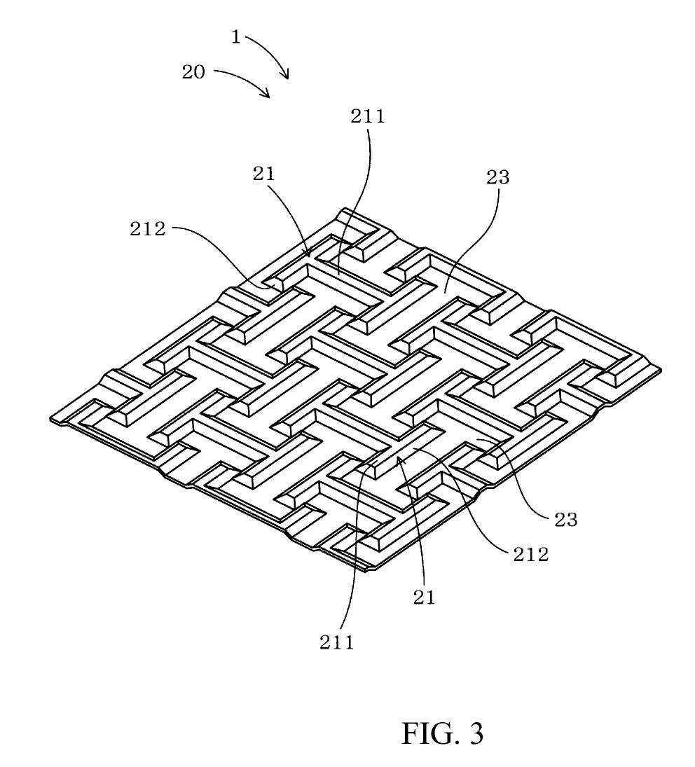

An embodiment of a sheet material 1 that has a concave-convex part 20 will now be explained, referencing FIG. 1 through FIG. 5.

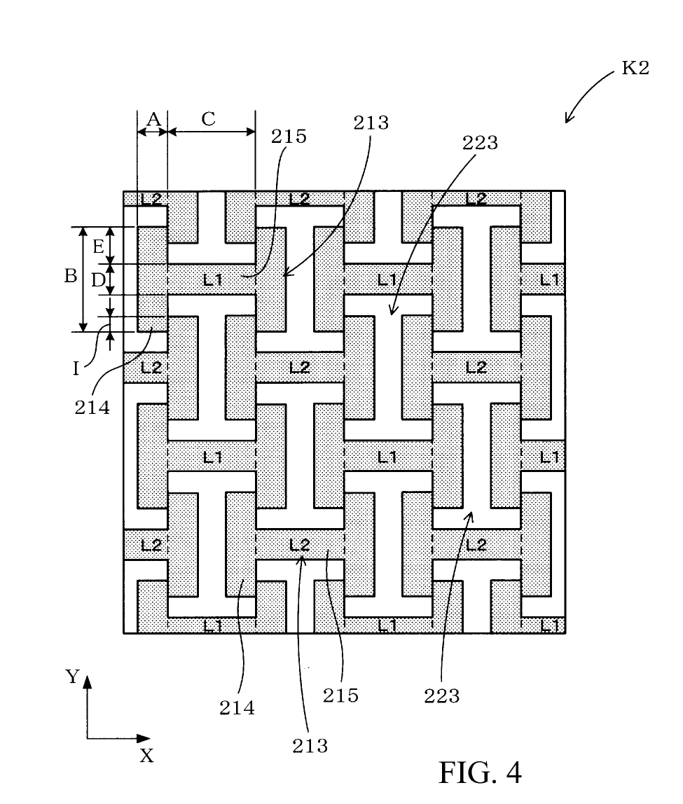

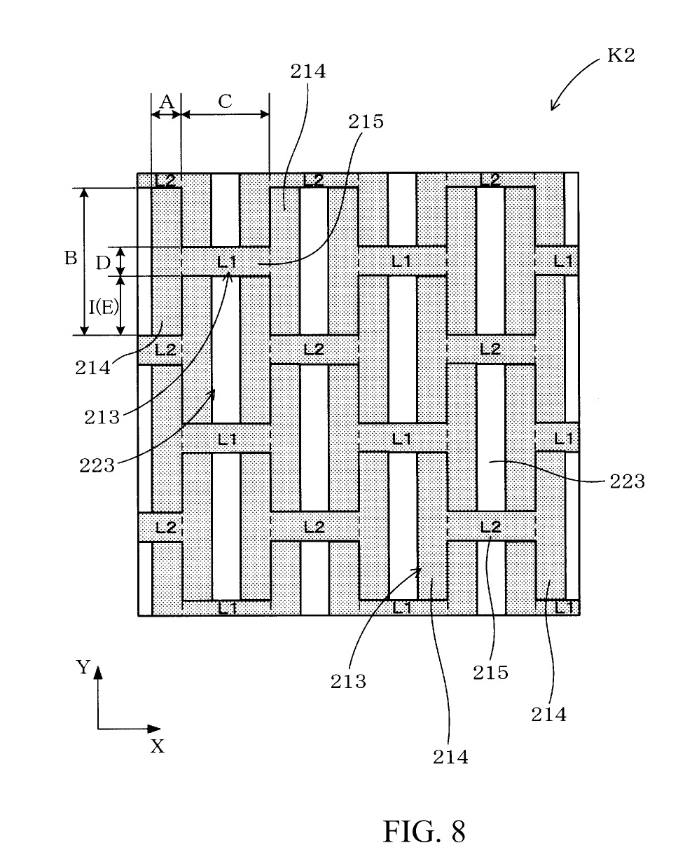

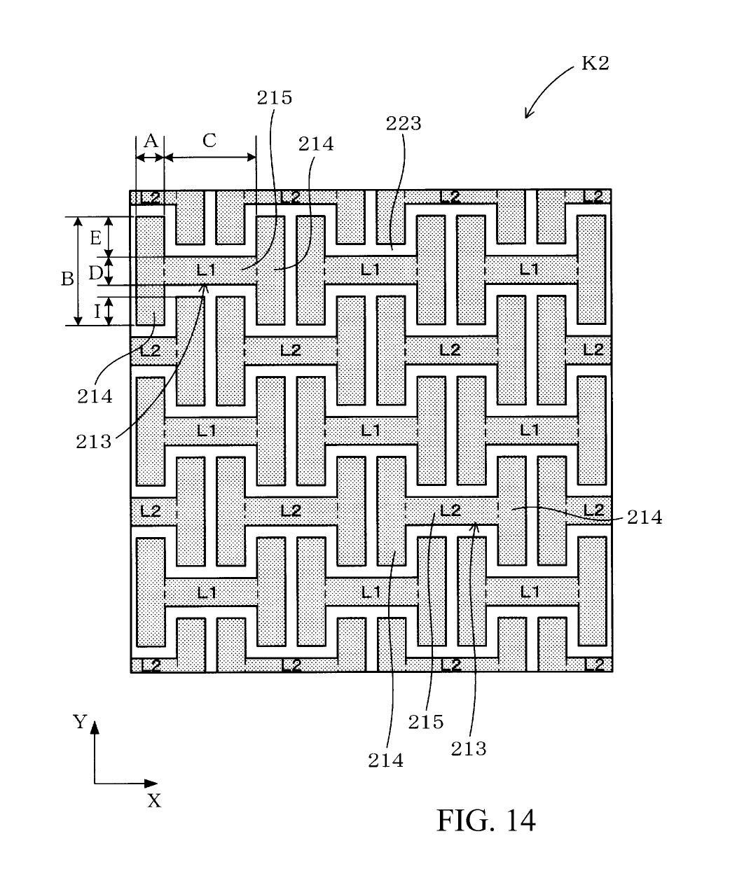

FIG. 4 shows the shape of the concave-convex part 20 of the sheet material 1 described in the present embodiment by the arrangement of first reference areas 213 and second reference areas 223 in a second reference plane K2. In the same figure, the solid lines indicate contour lines of the first reference areas 213 and the second reference areas 223, and the broken lines drawn on the inner sides of the contour lines of the first reference areas 213 indicate the boundaries between longitudinal bar parts 214 and latitudinal bar parts 215. In addition, symbols L1, L2 denoted inside each of the first reference areas 213 indicate the first reference area row to which that first reference area 213 belongs (the same applies to FIG. 8 and FIG. 14, which are discussed below).

The sheet material 1 that has the concave-convex part 20 of the present embodiment is the sheet material 1 whose stiffness has been increased by the formation of the concave-convex part 20, as shown in FIG. 1 through FIG. 3.

The concave-convex part 20 is configured as follows.

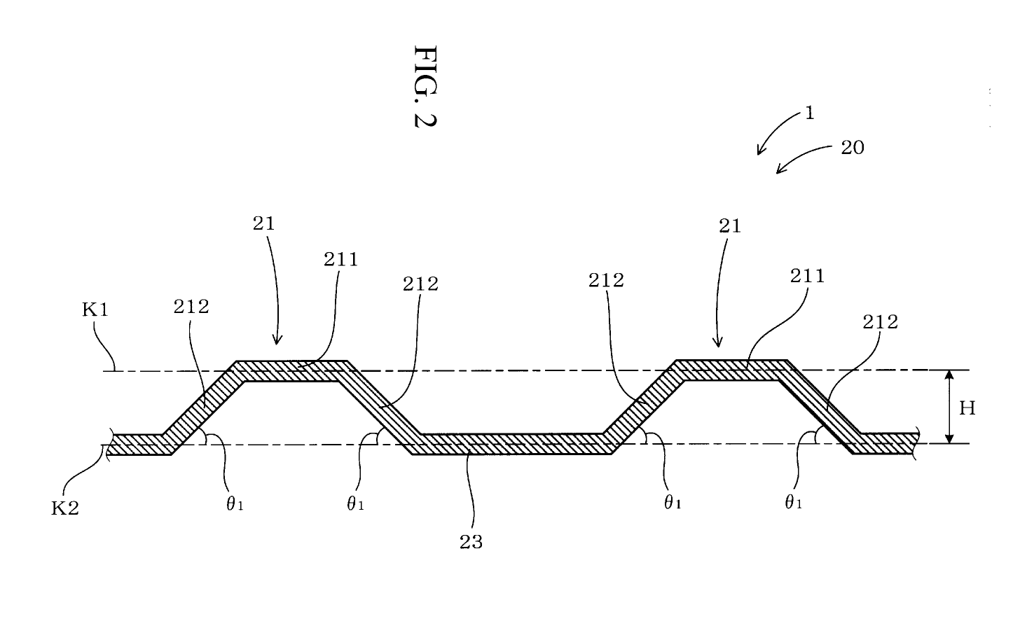

As shown in FIG. 2, a first reference plane K1 and the second reference plane K2, which are two virtual planes that are spaced apart from and parallel to one another, are used as a reference; furthermore, as shown in FIG. 4, a great number of the substantially H shaped first reference areas 213 are disposed in the same orientation in the second reference plane K2, with each of the first reference areas 213 comprising two of the longitudinal bar parts 214, which are parallel, and one of the latitudinal bar parts 215, which connects the two longitudinal bar parts 214 at their center portions. The longitudinal directions of the longitudinal bar parts 214 are the Y directions, and the directions orthogonal thereto are the X directions; furthermore, a plurality of the first reference area rows L1, L2 is formed wherein, in each of the first reference area rows L1, L2, a plurality of the first reference areas 213 is arrayed in a row in the X directions.

In addition, any arbitrary two rows of the first reference area rows L1, L2 adjacent to one another in the Y directions are disposed with a positional relationship such that a state obtains wherein a total of two of the longitudinal bar parts 214 of two of the first reference areas 213—one longitudinal bar part 214 per first reference area 213—adjacent to one another in the X directions and belonging to one of the first reference area rows penetrates the space between a pair of the longitudinal bar parts 214 of one of the first reference areas 213 belonging to the other first reference area row. As shown in FIG. 2, first areas 21 are provided, each of which protrudes from the first reference area 213 in the second reference plane K2 (FIG. 4) toward the first reference plane K1 and comprises a first top surface 211 that is a reduced projection of its first reference area 213 into the first reference plane K1 and first side surfaces 212 that connect the contour of that first top surface 211 and the contour of the corresponding first reference area 213.

As shown in FIG. 4, the plurality of first reference areas 213 arrayed in rows spaced apart by 8 mm in the X directions form the plurality of first reference area rows L1, L2 in the second reference plane K2 of the present embodiment. In the second reference plane K2 in the present embodiment, the first reference area rows L1 and the first reference area rows L2 are alternately disposed in the Y directions. In addition, any arbitrary two rows of the first reference area rows L1, L2 adjacent to one another in the Y directions are disposed such that a total of two of the longitudinal bar parts 214 of two of the first reference areas 213—one longitudinal bar part 214 per first reference area 213—adjacent to one another in the X directions and belonging to one of the first reference area rows penetrates the space between a pair of the longitudinal bar parts 214 of one of the first reference areas 213 belonging to the other first reference area row by a penetration I of 4 mm. Furthermore, in the present embodiment, the amount of protrusion E by which the longitudinal bar parts 214 protrude from the latitudinal bar parts 215 in the Y directions is 10 mm.

In addition, as shown in FIG. 4, the second reference areas 223, which are the areas excluding the first reference areas 213, coexist in the second reference plane K2, and plane areas 23 (FIG. 1 through FIG. 3) comprising those second reference areas 223 are provided in the second reference plane K2.

As shown in FIG. 4, each of the first reference areas 213 in the present embodiment is formed of: the longitudinal bar parts 214, each of which has a width dimension A (i.e., a reference dimension) in the X directions of 8 mm and a width dimension B in the Y directions of 28 mm; and one of the latitudinal bar parts 215, which has a width dimension C in the X directions of 24 mm and a width dimension D in the Y directions of 8 mm. At this time, the dimension B (mm) and the dimension D (mm) satisfy the relationship of B≧D+2A.

In addition, as shown in FIG. 2, the first reference plane K1 and the second reference plane K2 in the present embodiment are mutually parallel planes. The first top surface 211 is configured such that the center of the sheet thickness thereof overlaps the first reference plane K1, and the plane area 23 is configured such that the center of the sheet thickness thereof overlaps the second reference plane K2. Furthermore, in the present embodiment, the protrusion height H of each of the first areas 21 is 1.5 mm wherein the protrusion height H is the distance between the first reference plane K1 and the second reference plane K2.

In addition, as shown in FIG. 2, the inclination angle θ₁ of each of the first side surfaces 212 with respect to the second reference plane K2 is 30°.

In addition, in the present embodiment, the sheet material 1 that has the concave-convex part 20 is a 1000 series aluminum sheet whose sheet thickness t=0.3 mm prior to formation of the sheet. The concave-convex part 20 is press formed using a pair of molds. Furthermore, it is also possible to use, as the forming method, some other plastic working method such as roll forming that forms by using a pair of forming rolls, the surfaces of which are profiled with the desired concave-convex shape.

In addition, the ratio A/t of the reference dimension A (mm) to the sheet thickness t (mm) of the aluminum sheet is 26.67, and is within a range of 10-2000.

In addition, the ratio H/t of the distance H (mm), which is the distance between the first reference plane K1 and the second reference plane K2, to the sheet thickness t (mm) is 5. In addition, the inclination angle θ₁ formed between each of the first side surfaces 212 and the second reference plane K2 is 30°, and −3θ₁+272=182. Accordingly, the relationship 1≦H/t≦182 is satisfied.

Next, the operation and effects of the sheet material 1 that has the concave-convex part 20 according to the present embodiment will be explained.

As mentioned above, the concave-convex part 20 is provided with the first areas 21, each of which protrudes from the first reference areas 213 defined in the second reference plane K2 toward the first reference plane K1. Furthermore, each of the first areas 21 comprises one of the first top surfaces 211 and the first side surfaces 212, which connect the contour of that first top surface 211 and the contour of the corresponding first reference areas 213. In addition, the plane areas 23, which comprise the second reference areas 223, are provided in the second reference plane K2, wherein the second reference areas 223 are those areas in the second reference plane K2 excluding the first reference areas 213.

Because it has such a structure, the sheet material 1 has superior bending stiffness as well as superior energy absorption characteristics.

The following considers reasons why the stiffness is increased. Namely, as shown in FIG. 2, each of the first areas 21 comprises: one of the first top surfaces 211, which is disposed in the first reference plane K1 disposed at a position that is spaced apart from the neutral plane of the sheet material 1; and the first side surfaces 212 that intersect in the thickness directions of the sheet material 1. In addition, each of the plane areas 23 is disposed in the first reference plane K1 disposed at a position that is spaced apart from the neutral plane of the sheet material 1. Consequently, a large amount of the sheet material 1 can be disposed at a position that is spaced apart from the neutral plane of the sheet material 1. Accordingly, the large amount of material can be used effectively, and thereby the stiffness increase effect can be increased greatly.

In particular, the first reference areas 213, which are the basic shapes of the first areas 21, are each substantially H shaped, and the positional relationship of adjacency in the X directions is established as mentioned above, wherein the longitudinal bar parts 214 of two of the first reference areas 213 penetrate, in the Y directions, the space between the pair of longitudinal bar parts 214 of one of the first reference areas 213. Thereby, the second moment of area can be improved in any cross section taken along any direction, thereby making it possible to obtain a concave-convex shape with a superior bending stiffness increase effect and low stiffness anisotropy. In addition, attendant with the increase in the stiffness, it is also possible to obtain the effect of improving damping characteristics; in addition, the irregular shape makes it possible to obtain the effect of suppressing sound reverberations. In addition, attendant with the increase in the stiffness, it is also possible to obtain the effect of improving damping characteristics; in addition, the irregular shape makes it possible to obtain the effect of suppressing sound reverberations.

(FEM Analysis)

To quantitatively determine the stiffness increase effect of the sheet material 1 of the present embodiment, a bending stiffness evaluation of a cantilevered beam was performed by FEM analysis.

In the FEM analysis, the bending stiffness evaluation was performed in three directions, namely, 0°, 45°, and 90°, by changing the forming direction of the concave-convex part 20 in a test piece.

The test piece used in the FEM analysis has a rectangular shape measuring 120×120 mm, and the concave-convex part 20 is formed over the entire surface thereof. Furthermore, taking the increase in the surface area into consideration, the sheet thickness t was 0.284 mm.

In an end part of the test piece, one end was designated as a fixed end, and the end part disposed opposing that fixed end was designated as a free end. A load of 1 N was applied to the center part of the side formed by the free end, and the amount of deflection of the sheet material 1 was derived by performing the FEM analysis.

The evaluation was performed by comparing the amount of deflection obtained by conducting the same FEM analysis on the flat sheet shaped original sheet whereon the concave-convex part 20 is not formed.

<0° Direction>

As shown in FIG. 1, in the test piece wherein the concave-convex part 20 is formed such that the X directions in the second reference plane K2 (FIG. 4) and the sides formed by the sheet material 1 are parallel, the direction wherein an end part Z1 located above in the same figure is the fixed end and an end part Z2 opposing the end part Z1 is the free end is designated the 0° direction.

The sheet material 1 that has the concave-convex part 20 of the first embodiment was compared, in the 0° direction discussed above, with the flat sheet shaped original sheet, and it was obvious that the bending stiffness increased by 9.16 times.

<45° Direction>

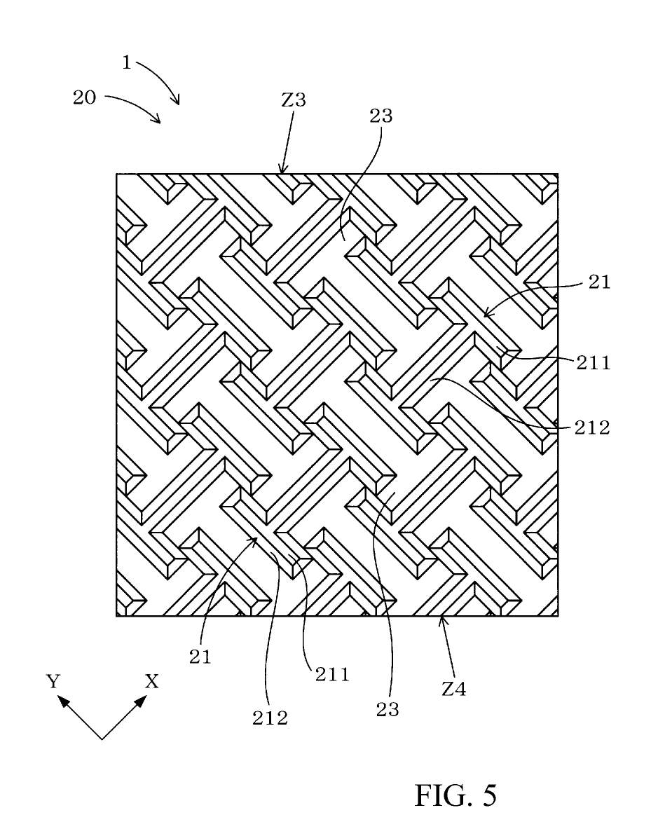

As shown in FIG. 5, in a test piece wherein the concave-convex part 20 is formed such that the angle formed between the X directions in the second reference plane K2 (FIG. 4) and the sides of the sheet material 1 is 45°, the direction wherein an end part Z3 located above in the same figure is the fixed end and an end part Z4 opposing the end part Z3 is the free end is designated the 45° direction.

The sheet material 1 that has the concave-convex part 20 of the first embodiment was compared, in the 45° direction discussed above, with the flat sheet shaped original sheet, and it was obvious that the bending stiffness increased by 6.83 times.

<90° Direction>

As shown in FIG. 1, in a test piece wherein the concave-convex part 20 is formed such that the X directions in the second reference plane K2 (FIG. 4) and the sides of the sheet material 1 are parallel, the direction wherein an end part Z5 located on the left side in the same figure is the fixed end and an end part Z6 opposing the end part Z5 is the free end is designated the 90° direction.

The sheet material 1 that has the concave-convex part 20 of the first embodiment was compared, in the 90° direction discussed above, with the flat sheet shaped original sheet, and it was obvious that the bending stiffness increased by 8.03 times.

Based on the results of the FEM analysis, with respect to the sheet material 1 that has the concave-convex part 20 described in the present embodiment, in the 0° direction, which is the direction in which the bending stiffness increase effect is the highest, a stiffness multiplier G is expected to be 9.16 times that of a flat sheet, and a weight reduction factor W (%) is expected to be approximately 52% of a flat sheet.

In addition, with respect to the sheet material 1 that has the concave-convex part 20 described in the present embodiment, in the 45° direction, which is the direction in which the bending stiffness increase effect is the lowest, the stiffness multiplier G is expected to be 6.83 times that of a flat sheet, and the weight reduction factor W (%) is expected to be at least approximately 47% of a flat sheet.

Furthermore, the weight reduction factor W (%) is derived using the stiffness multiplier G based on the formula W=(1−1³\sqrt{G})×100.

In addition, in the present embodiment, the shape of the concave-convex part 20 in the 135° direction is the same as in the 45° direction, and the shape of the concave-convex part 20 in the 180° direction is the same as in the 0° direction. Accordingly, the result of the FEM analysis is the same for both the 135° direction and the 45° direction, and is likewise the same for the 180° direction and the 0° direction.

### Second Embodiment

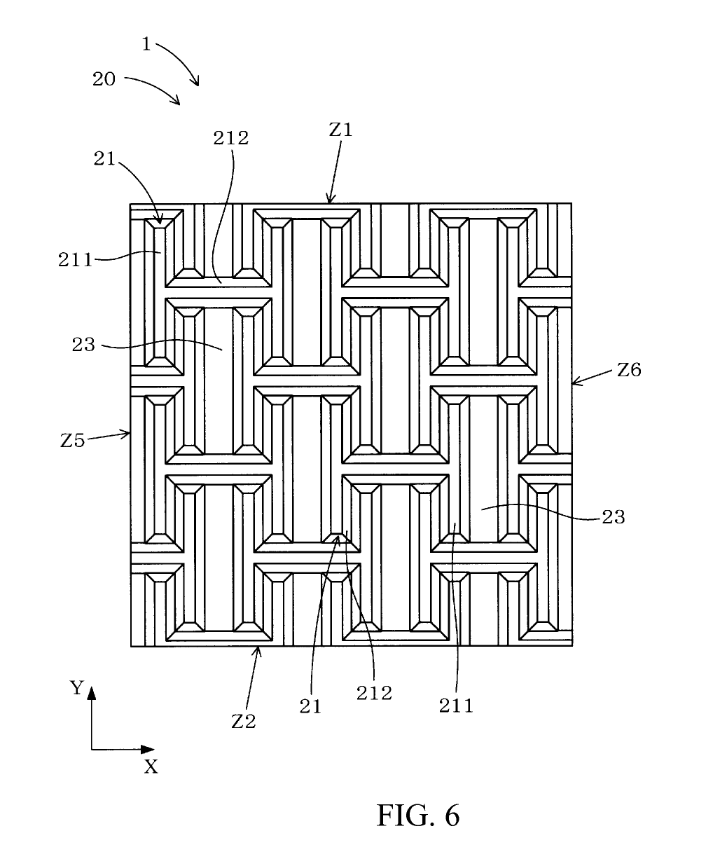

The sheet material 1 having the concave-convex part 20 according to the present embodiment will now be explained, referencing FIG. 6 through FIG. 9.

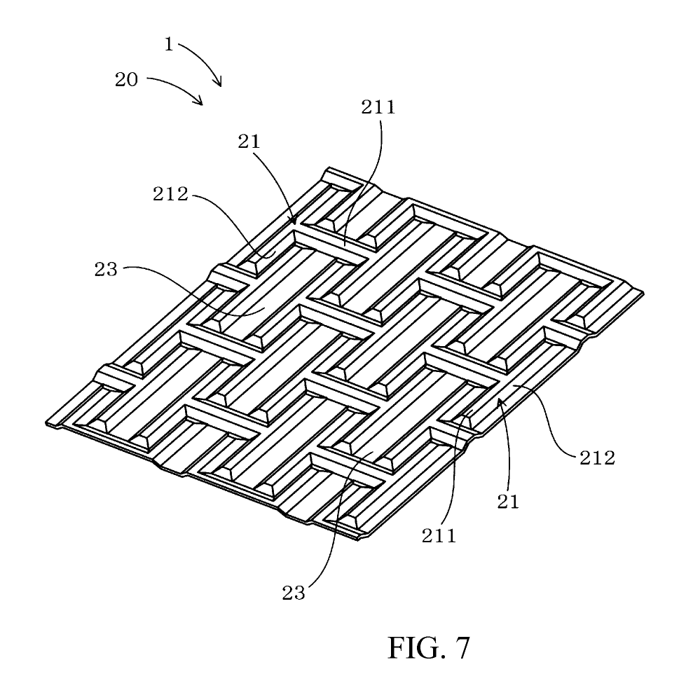

As shown in FIG. 8, the present embodiment is the sheet material 1 having the concave-convex part 20 shown in FIG. 6 and FIG. 7 wherein, in contrast to the first embodiment, the shape and the arrangement of the first reference areas 213 in the second reference plane K2 has been changed.

As shown in FIG. 8, each of the first reference areas 213 in the present embodiment is formed of: the longitudinal bar parts 214, each of which has the width dimension A (i.e., the reference dimension) in the X directions of 8 mm and the width dimension B in the Y directions of 40 mm; and one of the latitudinal bar parts 215, which has the width dimension C in the X directions of 24 mm and the width dimension D in the Y directions of 8 mm. At this time, the dimension B (mm) and the dimension D (mm) satisfy the relationship of B≧D+2A.

As shown in FIG. 8, the plurality of first reference areas 213 arrayed in rows spaced apart by 8 mm in the X directions form the plurality of first reference area rows L1, L2 in the second reference plane K2 of the present embodiment. In the second reference plane K2 in the present embodiment, the first reference area rows L1 and the first reference area rows L2 are alternately disposed in the Y directions. In addition, any arbitrary two rows of the first reference area rows L1, L2 adjacent to one another in the Y directions are disposed such that a total of two of the longitudinal bar parts 214 of two of the first reference areas 213—one longitudinal bar part 214 per first reference area 213—adjacent to one another in the X directions and belonging to one of the first reference area rows penetrates the space between a pair of the longitudinal bar parts 214 of one of the first reference areas 213 belonging to the other first reference area row by a penetration I of 16 mm. In addition, in the present embodiment, the amount of protrusion E by which the longitudinal bar parts 214 protrude from the latitudinal bar parts 215 in the Y directions is 16 mm. Namely, the tip parts of the longitudinal bar parts 214 and the latitudinal bar parts make contact between the first reference areas 213 adjacent in the Y directions. Furthermore, the configuration of the first areas 21 is the same as in the first embodiment.

In addition, as shown in FIG. 8, the second reference areas 223, which are the areas excluding the first reference areas 213, coexist in the second reference plane K2, and plane areas 23 (FIG. 6 and FIG. 7) comprising those second reference areas 223 are provided in the second reference plane K2.

(FEM Analysis)

To quantitatively determine the stiffness increase effect of the sheet material 1 of the present embodiment, a bending stiffness evaluation of a cantilevered beam was performed by FEM analysis.

In the FEM analysis, the evaluation was performed in three directions, namely, 0°, 45°, and 90°, by changing the forming direction of the concave-convex part 20 in a test piece.

The test piece used in the FEM analysis has a rectangular shape measuring 120×120 mm, and the concave-convex part 20 is formed over the entire surface thereof. Furthermore, taking the increase in the surface area into consideration, the sheet thickness t was 0.279 mm.

In an end part of the test piece, one end was designated as a fixed end, and the end part disposed opposing that fixed end was designated as a free end. A load of 1 N was applied to the center part of the side formed by the free end, and the amount of deflection of the sheet material 1 was derived by performing the FEM analysis.

The evaluation was performed by comparing the amount of deflection obtained by conducting the same FEM analysis on the flat sheet shaped original sheet whereon the concave-convex part 20 is not formed.

<0° Direction>

As shown in FIG. 6, in the test piece wherein the concave-convex part 20 is formed such that the X directions in the second reference plane K2 (FIG. 8) and the sides of the sheet material 1 are parallel, the direction wherein the end part Z1 located above in the same figure is the fixed end and the end part Z2 opposing the end part Z1 is the free end is designated the 0° direction.

The sheet material 1 that has the concave-convex part 20 of the present embodiment was compared, in the 0° direction discussed above, with the flat sheet shaped original sheet, and it was obvious that the bending stiffness increased by 10.86 times.

<45° Direction>

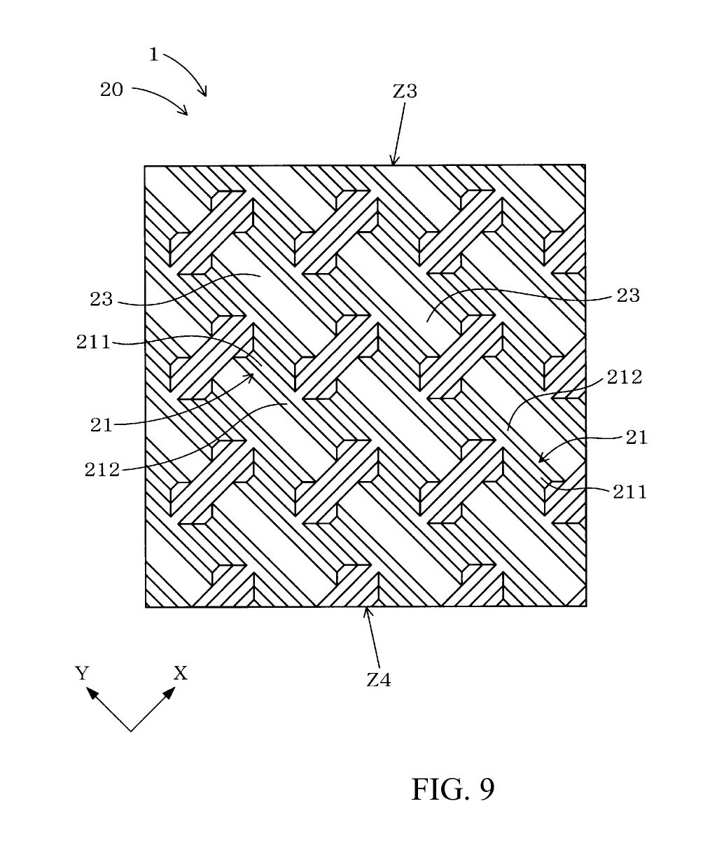

As shown in FIG. 9, in a test piece wherein the concave-convex part 20 is formed such that the angle formed between the X directions in the second reference plane K2 (FIG. 8) and the sides of the sheet material 1 is 45°, the direction wherein the end part Z3 located above in the same figure is the fixed end and the end part Z4 opposing the end part Z3 is the free end is designated the 45° direction.

The sheet material 1 that has the concave-convex part 20 of the present embodiment was compared, in the 45° direction discussed above, with the flat sheet shaped original sheet, and it was obvious that the bending stiffness increased by 5.48 times.

<90° Direction>

As shown in FIG. 6, in a test piece wherein the concave-convex part 20 is formed such that the X directions in the second reference plane K2 (FIG. 8) and the sides of the sheet material 1 are parallel, the direction wherein the end part Z5 located on the left side in the same figure is the fixed end and the end part Z6 opposing the end part Z5 is the free end is designated the 90° direction.

The sheet material 1 that has the concave-convex part 20 of the present embodiment was compared, in the 90° direction discussed above, with the flat sheet shaped original sheet, and it was obvious that the bending stiffness increased by 4.31 times.

Based on the result of the bending stiffness evaluation of a cantilevered beam performed by FEM analysis, it was obvious that the sheet material 1 having the concave-convex part 20 described in the present embodiment has a particularly superior stiffness increase effect in the 0° direction. In the 0° direction, the combined multiplier G is expected to be 10.86 times that of a flat sheet, and the weight reduction factor W (%) is expected to be approximately 55% of a flat sheet.

In addition, with respect to the sheet material 1 that has the concave-convex part 20 described in the present embodiment, in the 90° direction, which is the direction in which the bending stiffness increase effect is the lowest, the stiffness multiplier G is expected to be 4.31 times that of a flat sheet, and the weight reduction factor W (%) is expected to be at least approximately 39% of a flat sheet.

Furthermore, the weight reduction factor W (%) is derived using the stiffness multiplier G based on the formula W=(1−1³\sqrt{G})×100.

In addition, in the present embodiment, the shape of the concave-convex part 20 in the 135° direction is the same as in the 45° direction, and the shape of the concave-convex part 20 in the 180° direction is the same as in the 0° direction. Accordingly, the result of the FEM analysis is the same for both the 135° direction and the 45° direction, and is likewise the same for the 180° direction and the 0° direction.

### Third Embodiment

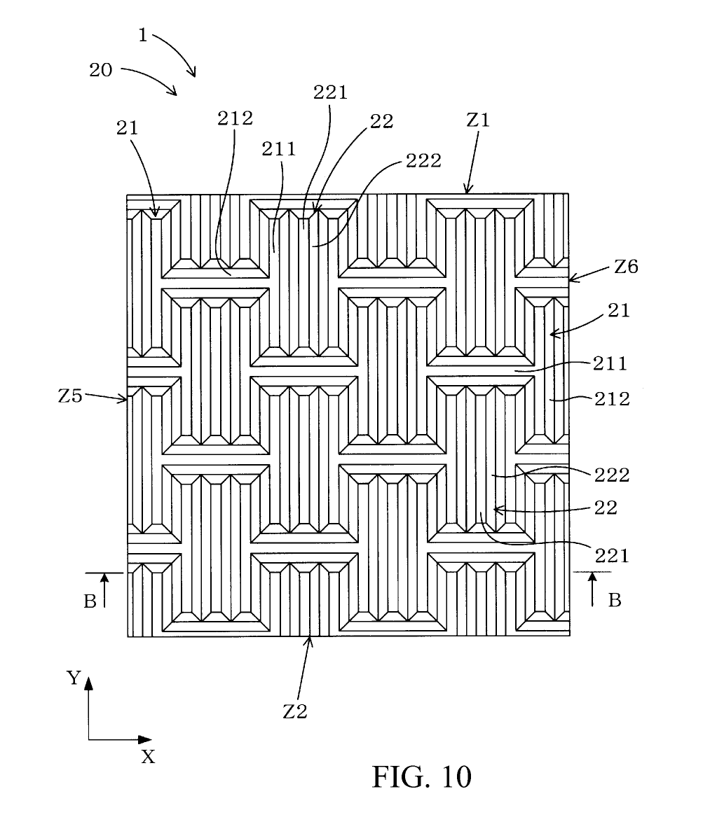

The sheet material 1 having the concave-convex part 20 according to the present embodiment will now be explained, referencing FIG. 10 through FIG. 12.

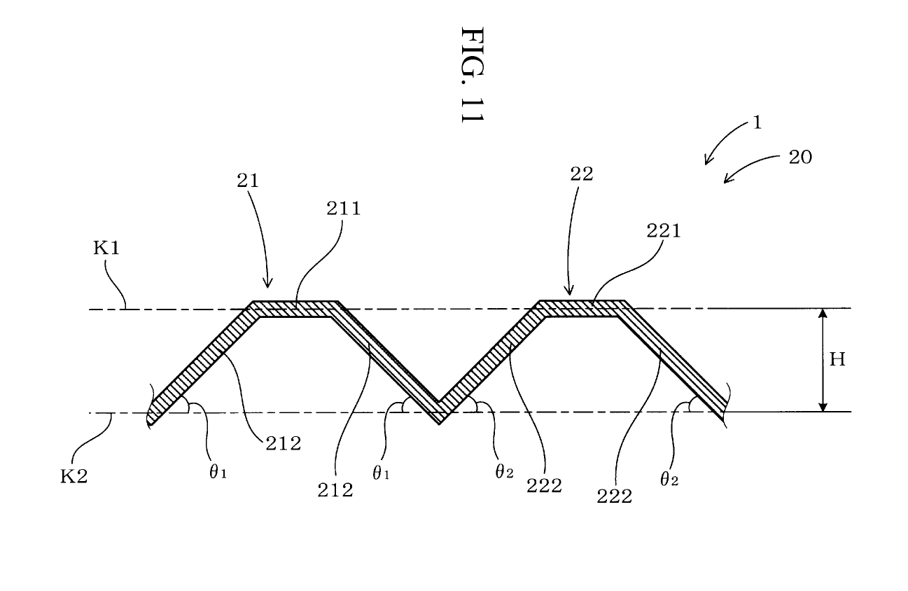

In the present embodiment, as in the second embodiment, the first reference areas 213 are disposed in the second reference plane K2, as shown in FIG. 8, and the first reference areas 213 and the second reference areas 223, which are the areas that exclude the first reference areas 213, are formed. The concave-convex part 20 of the present embodiment comprises the first areas 21 and second areas 22, wherein each of the second areas 22 comprises: a second top surface 221, which is a reduced projection of the corresponding second reference area 223 (FIG. 8) into the first reference plane K1, as shown in FIG. 10 and FIG. 11; and second side surfaces 222, which connect the contour of the corresponding second top surface 221 and the contour of the corresponding second reference areas 223. Like the inclination angle θ₁, the inclination angle θ₂ between each of the second side surfaces 222 and the second reference plane K2 is 30°. Furthermore, the configuration of each of the first areas 21 is the same as in the second embodiment.

(FEM Analysis)

To quantitatively determine the stiffness increase effect of the sheet material 1 of the present embodiment, a bending stiffness evaluation of a cantilevered beam was performed by FEM analysis.

In the FEM analysis, the evaluation was performed in three directions, namely, 0°, 45°, and 90°, by changing the forming direction of the concave-convex part 20 in a test piece.

The test piece used in the FEM analysis has a rectangular shape measuring 120×120 mm, and the concave-convex part 20 is formed over the entire surface thereof. Furthermore, taking the increase in the surface area into consideration, the sheet thickness t was 0.272 mm.

In an end part of the test piece, one end was designated as a fixed end, and the end part disposed opposing that fixed end was designated as a free end. A load of 1 N was applied to the center part of the side formed by the free end, and the amount of deflection of the sheet material 1 was derived by performing the FEM analysis.

The evaluation was performed by comparing the amount of deflection obtained by conducting the same FEM analysis on the flat sheet shaped original sheet whereon the concave-convex part 20 is not formed.

<0° Direction>

As shown in FIG. 10, in the test piece wherein the concave-convex part 20 is formed such that the X directions in the second reference plane K2 (FIG. 8) and the sides of the sheet material 1 are parallel, the direction wherein the end part Z1 located above in the same figure is the fixed end and the end part Z2 opposing the end part Z1 is the free end is designated the 0° direction.

The sheet material 1 that has the concave-convex part 20 of the present embodiment was compared, in the 0° direction discussed above, with the flat sheet shaped original sheet, and it was obvious that the bending stiffness increased by 8.11 times.

<45° Direction>

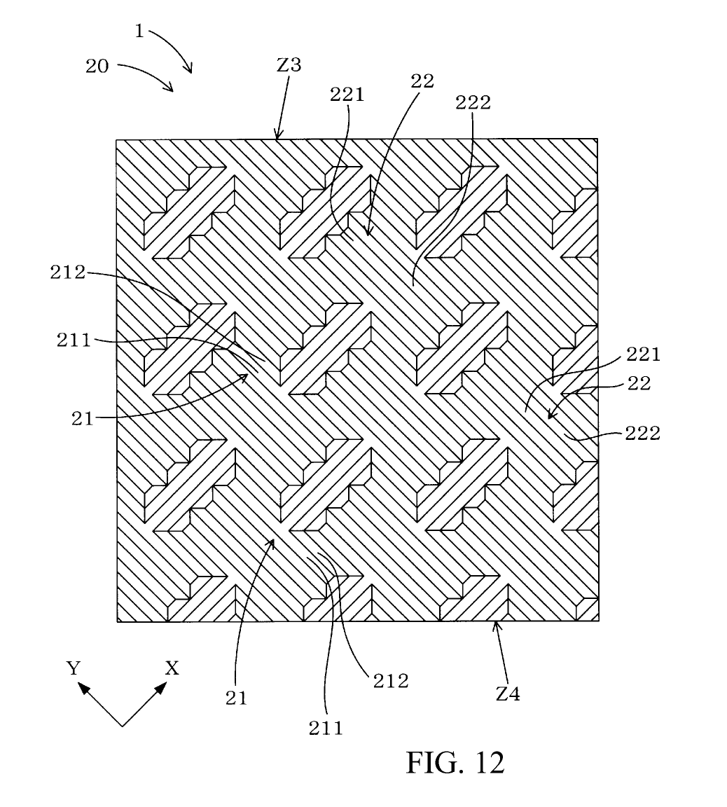

As shown in FIG. 12, in a test piece wherein the concave-convex part 20 is formed such that the angle formed between the X directions in the second reference plane K2 (FIG. 8) and the sides of the sheet material 1 is 45°, the direction wherein the end part Z3 located above in the same figure is the fixed end and the end part Z4 opposing the end part Z3 is the free end is designated the 45° direction.

The sheet material 1 that has the concave-convex part 20 of the present embodiment was compared, in the 45° direction discussed above, with the flat sheet shaped original sheet, and it was obvious that the bending stiffness increased by 3.92 times.

<90° Direction>

As shown in FIG. 10, in a test piece wherein the concave-convex part 20 is formed such that the X directions in the second reference plane K2 (FIG. 8) and the sides of the sheet material 1 are parallel, the direction wherein the end part Z5 located on the left side in the same figure is the fixed end and the end part Z6 opposing the end part Z5 is the free end is designated the 90° direction.

The sheet material 1 that has the concave-convex part 20 of the present embodiment was compared, in the 90° direction discussed above, with the flat sheet shaped original sheet, and it was obvious that the bending stiffness increased by 3.79 times.

Based on the result of the bending stiffness evaluation of a cantilevered beam performed by the abovementioned FEM analysis, it was obvious that the stiffness increase effect of the sheet material 1 having the concave-convex part 20 described in the present embodiment was particularly superior in the 0° direction. In the 0° direction, the combined multiplier G is expected to be 8.11 times that of a flat sheet, and the weight reduction factor W (%) is expected to be approximately 50% of a flat sheet.

In addition, in the 90° direction, which is the direction in which the bending stiffness increase effect is the lowest, the stiffness multiplier G is expected to be 3.79 times that of a flat sheet, and the weight reduction factor W (%) is expected to be at least approximately 36% of a flat sheet.

Furthermore, the weight reduction factor W (%) is derived using the stiffness multiplier G based on the formula W=(1−1³\sqrt{G})×100.

In addition, in the present embodiment, the shape of the concave-convex part 20 in the 135° direction is the same as in the 45° direction, and the shape of the concave-convex part 20 in the 180° direction is the same as in the 0° direction. Accordingly, the result of the FEM analysis is the same for both the 135° direction and the 45° direction, and is likewise the same for the 180° direction and the 0° direction.

### Fourth Embodiment

The present embodiment is an example wherein, in contrast to the first through third embodiments, the shape and arrangement of the first reference areas 213 in the second reference plane K2 has been changed. In the present embodiment, the shape of the sheet material 1 having the concave-convex part 20 is described by the arrangement of the first reference areas 213 alone or of the first reference areas 213 and the second reference areas 223 in the second reference plane K2. In either case, the sheet material 1 having the concave-convex part 20 is formed based on the second reference plane K2 shown in the figure.

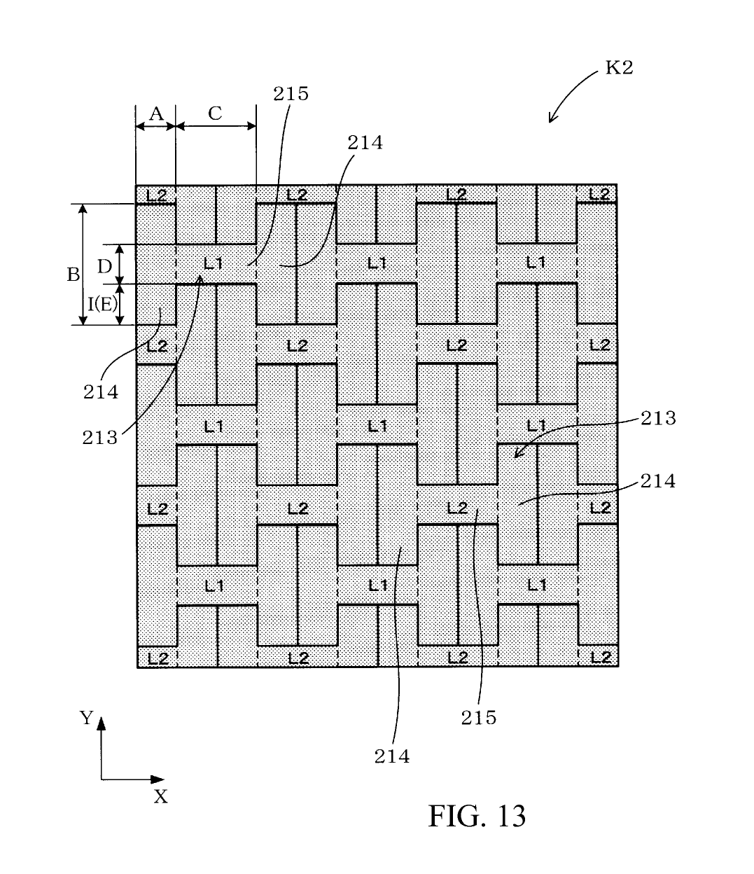

In FIG. 13, the solid lines indicate the contour lines of the first reference areas 213, and the broken lines drawn on the inner sides of the contour lines of the first reference areas 213 indicate the boundaries between the longitudinal bar parts 214 and the latitudinal bar parts 215. In addition, the symbols L1, L2 denoted inside each of the first reference areas 213 indicates the first reference area row to which that first reference area 213 belongs.

In the second reference plane K2 shown in FIG. 13, the first reference areas 213, wherein the reference dimension A=8 mm, the dimension B=24 mm, the dimension C=16 mm, and the dimension D=8 mm, are spread out without any gaps, and the first reference area rows L1, L2 are formed in the state wherein the first reference areas 213 that are adjacent in the X directions contact one another. In addition, in the Y directions, the penetration I between the adjacent first reference area rows L1, L2 is 8 mm. In the present embodiment, the amount of protrusion E by which the longitudinal bar parts 214 protrude from the latitudinal bar parts 215 in the Y directions is 8 mm. Namely, the tip parts of the longitudinal bar parts 214 and the latitudinal bar parts 215 make contact between the first reference areas 213 that are adjacent in the Y directions. In this case, the concave-convex part 20 comprises only the first areas 21. Furthermore, the configuration of the first areas 21 is the same as that of the first embodiment.

In the second reference plane K2 shown in FIG. 14, the first reference area rows L1, L2 are formed such that the distance between the first reference areas 213, wherein the dimension A=6 mm, the dimension B=22 mm, the dimension C=18 mm, and the dimension D=6 mm, that are adjacent in the X directions is 2 mm. In addition, in the Y directions, the penetration I between the adjacent first reference area rows L1, L2 is 6 mm. Furthermore, in the present embodiment, the amount of protrusion E by which the longitudinal bar parts 214 protrude from the latitudinal bar part 215 in the Y directions is 8 mm.

In addition, in the second reference plane K2 shown in FIG. 14, the first reference area rows L1 and the first reference area rows L2 are disposed alternately in the Y directions. The areas excluding the first reference areas 213 are the second reference areas 223, and the plane areas 23 are formed of those second reference areas 223. In this case, the concave-convex part 20 is formed from the first areas 21 and the plane areas 23. Furthermore, the configuration of the first areas 21 is the same as that of the first embodiment.

In the sheet material 1 having the concave-convex part 20 in the second reference plane K2 described in the present embodiment, too, it is possible to obtain the sheet material 1 with low bending stiffness anisotropy and a high bending stiffness increase effect.

### Fifth Embodiment

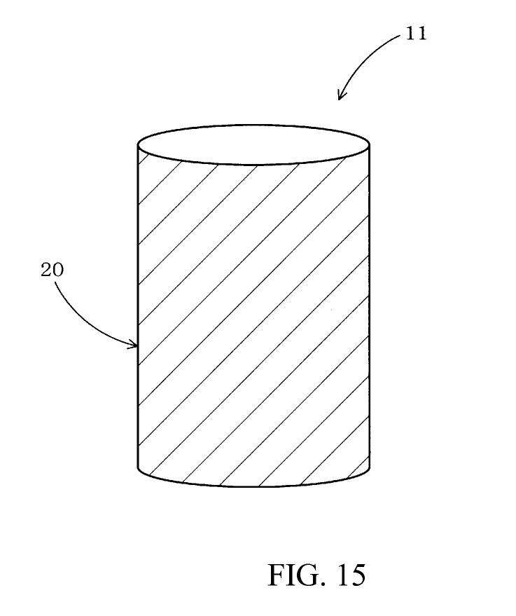

The present embodiment, as shown in FIG. 15, is an example wherein the concave-convex part 20 is provided to a cylindrical member 11. In the present embodiment, the first reference plane K1 and the second reference plane K2 are cylindrical curved planes that are disposed parallel to one another. The second reference plane K2 in the present embodiment is the planar second plane K2 of any of the first through fourth embodiments that has been bent into a cylindrical shape. The configurations of the first areas 21, the second areas 22, and the plane areas 23, which constitute the concave-convex part 20, are the same as in the first through fourth embodiments.

As described in the present embodiment, the sheet material 1 that has the concave-convex part 20 provided with superior characteristics can be deformed into a variety of shapes, thereby expanding its range of application.

In addition, by using a cylindrical structure like a beverage can or a rocket, it is possible to increase the stiffness of the cylindrical member 11 that has the concave-convex part 20 described in the present embodiment without increasing the sheet thickness of the material. In addition, the cylindrical member 11 of the present embodiment has superior energy absorption characteristics. Consequently, using such in a vehicle body of an automobile and the like imparts high stiffness and superior energy absorption characteristics.

### Sixth Embodiment

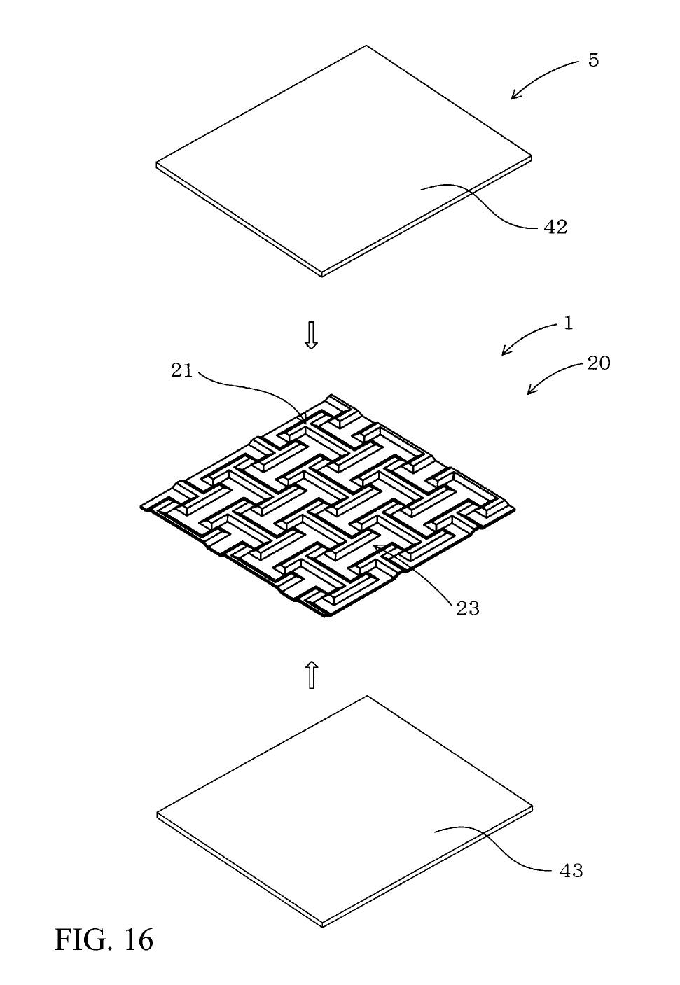

The present embodiment, as shown in FIG. 16, is an example wherein a laminated structure 5 is configured using as the core material the sheet material 1 that has the concave-convex part 20 of the first embodiment.

Namely, the laminated structure 5 joins face sheets 42, 43 to the surfaces on both sides of the core material, which consists of one sheet material 1 that has the concave-convex part 20.

The face sheets 42, 43 are aluminum alloy sheets that are made of 3000 series material and whose sheet thickness is 1.0 mm.

In the laminated structure 5 of the present embodiment, the sheet material 1 that has the concave-convex part 20, which has superior stiffness as discussed above, is used as the core material, and the face sheets 42, 43 are joined, by bonding, brazing, and the like, to the first top surfaces 211 of the first areas 21 and to the plane areas 23; thereby, the laminated structure 5 obtains a remarkably higher stiffness than that of the sheet material 1 that has the concave-convex part 20 as a standalone. Moreover, because the sheet material 1 and the face sheets 42, 43 are aluminum alloy sheets, the weight is also reduced.

In addition, it is possible to obtain the effect of improving the damping characteristics attendant with the increase in stiffness, and to obtain the effect of improving the sound absorbing characteristics by virtue of containing air layers. In addition, as is well known, the sound absorbing characteristics can be further improved via the formation of a through hole in either of the face sheets 42, 43 so as to form a Helmholtz sound-absorbing structure.

Furthermore, it is also possible to use, as the face sheets 42, 43, a sheet made of resin or a metal other than an aluminum alloy, for example, a steel sheet or a titanium sheet.

### Seventh Embodiment

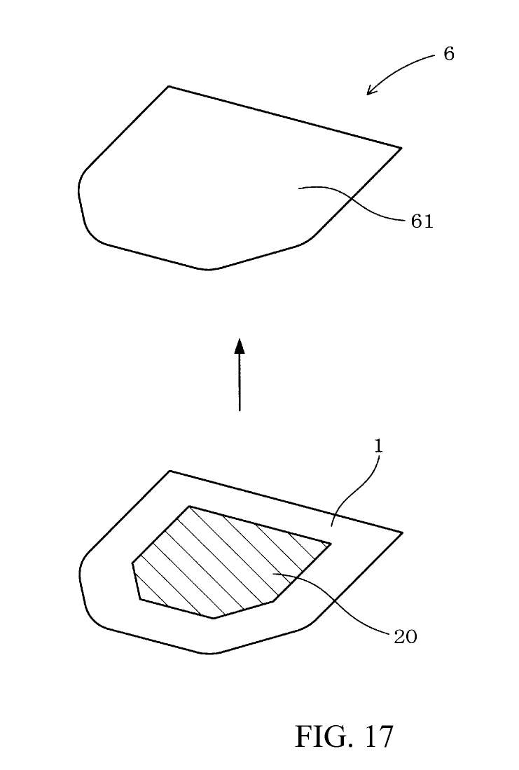

The present embodiment, as shown in FIG. 17, is an example of a vehicle panel 6 that is configured by using as the inner panel the sheet material 1 according to the first through the fourth embodiments, and disposing the surfaces of the sheet material 1 on the first reference plane K1 side toward the rear surface side of an outer panel 61. The outer panel 61 is joined, by hemming and the like, to an outer circumferential part of the inner panel. Furthermore, in the inner panel discussed above, the forming direction of the concave-convex part 20 is not limited; for example, a configuration can also be adopted wherein the surface on the second reference plane K2 side of the sheet material 1 is disposed such that it faces the rear surface side of the outer panel 61.

In the vehicle panel 6 of the present embodiment, the sheet material 1 that has the concave-convex part 20 and that constitutes the inner panel obtains an excellent stiffness increase effect, as mentioned above, and therefore has the excellent characteristic of absorbing the energy of a primary impact as well as the energy of a secondary impact in the event the vehicle collides with a pedestrian. In addition, it is possible to obtain the effect of improving the damping characteristics attendant with the increase in stiffness, and to obtain the effect of improving the sound absorbing characteristics by virtue of containing an air layer.

Furthermore, in the present embodiment, the sheet material 1 that has the concave-convex part 20 is used as the inner panel, but the sheet material 1 can also be used as the inner panel or the outer panel 61, or both.

1. A sheet material having a stiffness-increasing concave-convex part, wherein
a first reference plane and a second reference plane, which are two virtual planes that are spaced apart from and parallel to one another, serve as a reference system;
numerous at least substantially H shaped first reference areas, each comprising two parallel longitudinal bar parts and a latitudinal bar part that connects center portions of the two parallel longitudinal bar parts together, are arrayed with the same orientation in the second reference plane;
a plurality of first reference area rows is formed such that longitudinal directions of the longitudinal bar parts are Y directions and directions orthogonal thereto are X directions, wherein a plurality of the first reference areas is arrayed in a row in the X directions in each of the first reference area rows;
any arbitrary two rows of the first reference area rows adjacent to one another in the Y directions are disposed in a positional relationship such that a total of two of the longitudinal bar parts of two of the first reference areas—one longitudinal bar part per first reference area—, which are adjacent to one another in the X directions and belong to one of the first reference area rows, penetrates a space between a pair of the longitudinal bar parts of one of the first reference areas belonging to the other first reference area row; and
the concave-convex part includes first areas, each of which comprises:
a first top surface that protrudes from the first reference area in the second reference plane toward and into the first reference plane and has an area equal to or less than the first reference area, and
a plurality of first side surfaces that respectively connect an outer periphery of the first top surface to an outer periphery of the corresponding first reference area.

2. The sheet material according to claim 1, wherein
the first reference areas and second reference areas, which are areas that exclude the first reference areas, coexist in the second reference plane; and
the concave-convex part includes second areas, each of which comprises:
a second top surface that protrudes from the second reference area toward and into the first reference plane and has an area equal to or less than the second reference area, and
a plurality of second side surfaces that respectively connect an outer periphery of the second top surface to an outer periphery of the corresponding second reference area, or plane areas, each of which comprises the second reference area in the second reference plane.

3. The sheet material according to claim 2, wherein
a width dimension in the X directions of each of the longitudinal bar parts is designated as a reference dimension A (mm), and a width dimension B (mm) in the Y directions of each of the longitudinal bar parts with respect to the reference dimension A (mm) satisfies the relationship 3A≦B≦13A;
a width dimension C (mm) in the X directions of each of the latitudinal bar parts with respect to the reference dimension A (mm) satisfies the relationship 2A≦C≦10A;
a width dimension D (mm) in the Y directions of each of the latitudinal bar parts with respect to the reference dimension A (mm) satisfies the relationship A≦D≦3A; and
the dimension B (mm) and the dimension D (mm) satisfy the relationship B≧D+2A.

4. The sheet material according to claim 3, wherein
an inclination angle θ₁(°) of each first side surface with respect to the second reference plane is within the range of 10°-90°; and
an inclination angle θ₂(°) of each second side surface with respect to the second reference plane is within the range of 10°-90°.

5. The sheet material according to claim 3, wherein
at least part of the first reference plane and at least part of the second reference plane are parallel curved surfaces.

6. The sheet material according to claim 3, wherein
the concave-convex part is formed by press forming a metal sheet.

7. The sheet material according to claim 3, wherein
the metal sheet prior to the press forming has a sheet thickness t (mm) of 0.03-6.0 mm.

8. The sheet material according to claim 7, wherein
a ratio A/t of the reference dimension A (mm) to the thickness t (mm) is 10-2000.

9. The sheet material according to claim 8, wherein
a ratio H/t of a distance H (mm) between the first reference plane and the second reference plane to the sheet thickness t (mm), and a maximum inclination angle θ₁(°) formed between each first side surface and the second reference plane satisfy the relationship 1≦(H/t)≦−3θ₁+272; and
the ratio H/t and the maximum inclination angle θ₂(°) formed between each second side surface and the second reference plane satisfy the relationship 1≦(H/t)≦−3θ₂+272.

10.-11. (canceled)

12. The sheet material according to claim 9, wherein
the inclination angle θ₁(°) of each first side surface with respect to the second reference plane is within the range of 10°-70°; and
an inclination angle θ₂(°) of each second side surface with respect to the second reference plane is within the range of 10°-70°.

13. The sheet material according to claim 12, wherein
each of the inclination angles θ₁(°) and θ₂(°) is 30°.

14. The sheet material according to claim 1, wherein
a width dimension in the X directions of each of the longitudinal bar parts is designated as a reference dimension A (mm), and a width dimension B (mm) in the Y directions of each of the longitudinal bar parts with respect to the reference dimension A (mm) satisfies the relationship 3A≦B≦13A;
a width dimension C (mm) in the X directions of each of the latitudinal bar parts with respect to the reference dimension A (mm) satisfies the relationship 2A≦C≦10A;
a width dimension D (mm) in the Y directions of each of the latitudinal bar parts with respect to the reference dimension A (mm) satisfies the relationship A≦D≦3A; and
the dimension B (mm) and the dimension D (mm) satisfy the relationship B≧D+2A.

15. The sheet material according to claim 14, wherein
the inclination angle θ₁(°) of each first side surface with respect to the second reference plane is within the range of 10°-90°; and
an inclination angle θ₂(°) of each second side surface with respect to the second reference plane is within the range of 10°-90°.

16. The sheet material according to claim 15, wherein
the inclination angle θ₁(°) is within the range of 10°-70°; and
the inclination angle θ₂(°) is within the range of 10°-70°.

17. The sheet material according to claim 16, wherein
each of the inclination angles θ₁(°) and θ₂(°) is 30°.

18. The sheet material according to claim 1, wherein
at least part of the first reference plane and at least part of the second reference plane are parallel curved surfaces.

19. The sheet material according to claim 1, wherein
the concave-convex part is formed by press forming a metal sheet.

20. The sheet material according to claim 19, wherein
the metal sheet prior to the press forming has a sheet thickness t (mm) of 0.03-6.0 mm.

21. The sheet material according to claim 20, wherein
a ratio A/t of a reference width dimension A (mm) to the thickness t (mm) is 10-2000.

22. The sheet material according to claim 21, wherein
a ratio H/t of a distance H (mm) between the first reference plane and the second reference plane to the sheet thickness t (mm), and a maximum inclination angle θ₁(°) formed between each first side surface and the second reference plane satisfy the relationship 1≦(H/t)≦−3θ₁+272; and
the ratio H/t and the maximum inclination angle θ₂(°) formed between each second side surface and the second reference plane satisfy the relationship 1≦(H/t)≦−3θ₂+272.
